(19) United States
(12) Patent Application Publication
(10) Pub. No.: US 2013/0311232 A1
(43) Pub. Date: Nov. 21, 2013

(54) Method, System and Program Product for Forecasting

(71) Applicant: Louis Rick Morris, Hiram, GA (US)

(72) Inventor: Louis Rick Morris, Hiram, GA (US)

(21) Appl. No.: 13/472,163

(22) Filed: May 15, 2012

(51) Int. Cl. G06Q 30/02

(52) U.S. Cl. 705/7.31

(57) ABSTRACT

A method, system and program product comprise selecting at least one item and historical demand information for the item from a storage portion. A plurality of discrete values for use with forecast models are specified. The item, historical demand information and discrete values are communicated to a forecasting unit comprising at least one test portion being configured for testing the historical demand information to determine a type for the historical demand information. A selection portion is configured for selecting at least a one of a plurality of forecast model portions and for transferring the historical demand information to the selected forecast model portion. A model selection portion is configured for selecting at least one of a plurality of forecast models from the selected forecast model portion. A forecast portion is configured to generate a forecast using at least the historical demand information and the selected forecast model.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to systems for processing information. More particularly, one or more embodiments of the invention relate to forecasting systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Inventory can be the largest physical asset on a distribution or retail company's balance sheet. Distribution or retail intensive companies face the daily challenge of determining how much inventory to stock to satisfy current and upcoming demand. Too little inventory results in item unavailability, potentially resulting in lost sales opportunities. Alternatively, too much inventory results in excessive costs tied to large credit lines financing the inventory, warehousing and labor costs, insurance and property taxes. Additionally, improper management of inventory can result in business failure.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram an example forecasting system, in accordance with an embodiment of the present invention;

FIG. 2 presents an example table of forecast models for the example forecasting system described with reference to FIG. 1, in accordance with an embodiment of the present invention;

FIG. 3 presents an example table of recursive calculations for the example forecasting system described with reference to FIG. 1, in accordance with an embodiment of the present invention;

FIG. 4 presents an example table of state space equations for the example forecasting system described with reference to FIG. 1, in accordance with an embodiment of the present invention;

FIG. 5 illustrates an example method for the forecasting system as described with reference to FIGS. 1-4, in accordance with an embodiment of the present invention;

FIG. 6 illustrates a block diagram depicting a conventional client/server communication system; and

FIG. 7 illustrates a typical computer system that, when appropriately configured or designed, may serve as a computer system 700 for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A forecasting system will be described which provides means and methods for processing to select a forecast model and to perform forecast processing. The processing for forecast model selection uses discrete values in order to reduce processing time as compared to conventional systems. Additionally, the forecasting system performs damping and weekly indexing in order to improve forecast model accuracy. The forecasting system also provides for storage and retrieval of historical demand information used for processing.

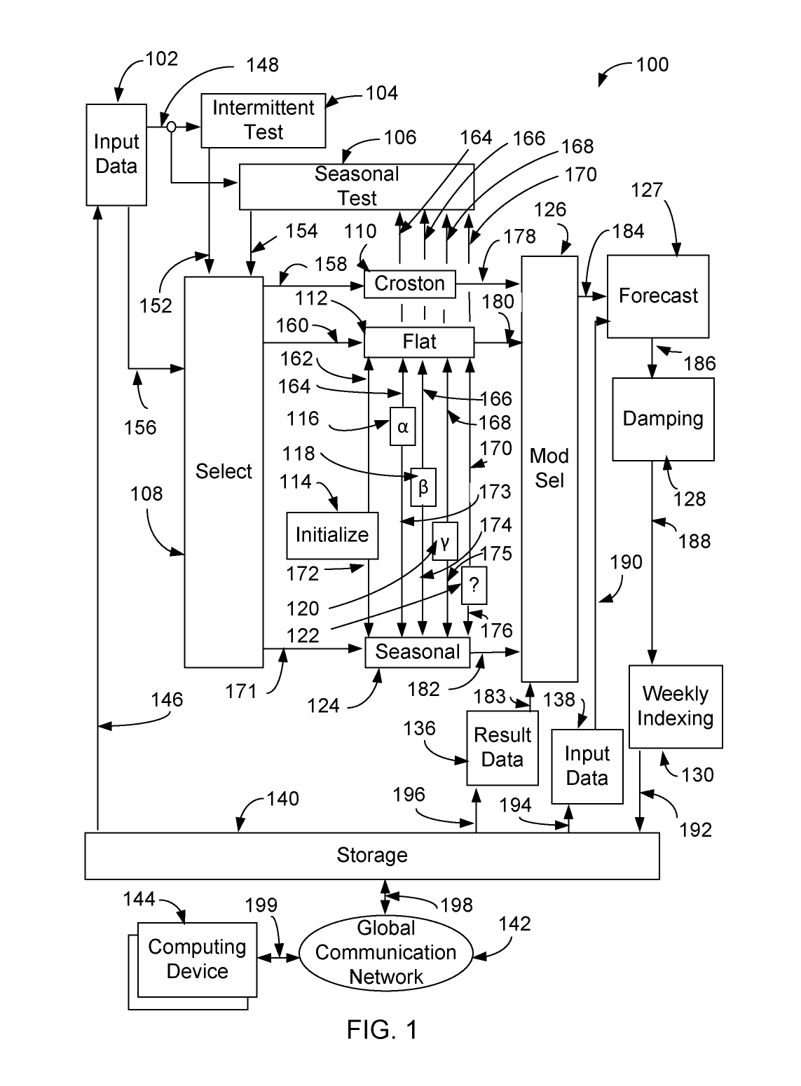

The system will now be described in detail with reference to FIGS. 1-7.

FIG. 1 is a block diagram an example forecasting system, in accordance with an embodiment of the present invention.

A forecasting system 100 includes an input data portion 102, an intermittent test portion 104, a seasonal test portion 106, a select portion 108, a Crosten portion 110, a flat processing portion 112, an initialize portion 114, an alpha portion 116, a beta portion 118, a gamma portion 120, a phi portion 122, a seasonal processing portion 124, a model selection portion 126, a forecast portion 127, a damping portion 128, a weekly indexing portion 130, a result data portion 136, an input data portion 138, a storage portion 140, a global communication network 142 and multiplicity of computing devices with a sampling noted as a computing device 144.

Input data portion 102 provides input stimulus information associated with prior or historical operations. Intermittent test portion 104 determines if received information is intermittent. Seasonal test portion 106 determines if received information is seasonal. Select portion 108 selects to apply received information to an input based upon received controlling information. Crosten portion 110 is a forecasting strategy for information associated with intermittent demand. Crosten portion 110 operates in two steps with the first step operating to separate exponential smoothing estimates based upon the average size of demand and the second step operating to perform an average interval between demand calculation. Flat processing portion 112 performs forecasting for trending non-seasonal information which typically results in a straight line or flat forecast.

Alpha portion 116 communicates a multiplicity of alpha values. Alpha portion 116 provides an adjustment parameter that emphasizes more recent periods of history versus longer periods of history for generating a forecast. As a non-limiting example, the values communicated by alpha portion 116 may range from 0.95, considered aggressive, to 0.15, considered less aggressive. The values provided by alpha portion 116 generate a smoothing effect on the forecast curve which can be viewed while modeling a variety of settings. A value of zero provided by alpha portion 116 configures even weighting over the associated periods. A comparatively low value, 0.15 for example, provided by alpha portion 116 places slightly more weight on the recent year of history. A larger value, 0.95 for example, provided by alpha portion 116 places more weight on the last 6 months of historical information. Values of 0.75 and higher, for example, provided by alpha portion 116 are considered as aggressive and are used with an associated dampening percent tolerance in order to prevent the forecast from overreacting to recent demand. As a non-limiting example, alpha portion 116 may provide a discrete number of values such as 0.15, 0.35, 0.55, 0.75 and 0.95.

Beta portion 118 provides a multiplicity of beta values. The values provided by beta portion 118 control the trend sensitivity associated with a forecast. The values provide by beta portion 118 tend to be small numbers. In general, the smaller the value provide by beta portion 118, the less of the effect associated with the trend on the forecast. As a non-limiting example, the values provided by beta portion 118 range between zero and 1.18E-09 (in scientific notation). As a non-limiting example, beta portion 118 may provide a discrete number of values such as 0.5, 0.055, 0.00605, 0.0006655, 8.86E-07 and 1.18E-09.

Gamma portion 120 provides a multiplicity of gamma values. The values provided by gamma portion 120 control the sensitivity of a forecast with respect to seasonality. In general, the values provide by gamma portion 120 are small and typically are expressed in scientific notation. As a non-limiting example, the values provided by gamma portion 120 range between zero and 1E-10. The smaller the value provided by gamma portion 120, the less weight is given to seasonality. In general, the values provided by gamma portion 120 are used by the Holt-Winters exponential smoothing methods performed by forecasting system 100. As a non-limiting example, gamma portion 120 may provide a discrete number of values such as 0.01, 1E-06, 1E-08 and 1E-10

Phi portion 122 provides a multiplicity of phi values. The values provided by phi portion 122 works in conjunction with values provided by gamma portion 120 in order to fine tune trend in the Holt Winters models used by forecasting system 100. The values provided by phi portion 122 control the sensitivity of the forecast to large trends in recent time periods and control the speed of the dampening of a forecast when returning to the mean. As a non-limiting example, the values provided by phi portion 122 range between 0.2 and 1. In general, the smaller the value provided by phi portion 122, the more dampening which results in less of an impact associated with the trend on the forecast. As a non-limiting example, phi portion 122 may provide a discrete number of values such as 0.2, 0.5 and 1.0.

Seasonal processing portion 124 performs forecasting for seasonal information. Model selection portion 126 selected a forecast model. Forecast portion 127 receives information and performs an estimate of a forecast based upon the received information. Damping portion 128 receives information and performs damping of the information. Weekly indexing portion 130 receives information and performs weekly indexing of the information. Result data portion 136 provides result information associated with the information provided by input data portion 102. Input data portion 138 provides information used for generating a forecast based upon the information. Storage portion 140 receives, stores, retrieves and transmits information. As a non-limiting example, storage portion 140 may be configured as a database. Global communication network provides communication between entities. Computing device 144 receives, transmits, stores, retrieves, processes and presents information. As a non-limiting example, computing device 144 may present graphical representations of forecast information versus demand history as processed via forecasting system 100. Furthermore, computing device 144 may present alerts associated with forecast issues as processed via forecasting system 100. As a non-limiting example, an alert may be related to a possible erroneous forecast (e.g. forecast with a large number of zeros).

Input data portion 102 receives information from storage portion 140 via a communication channel 146. Intermittent test portion 104 receives information from input data portion 102 via a communication channel 148. Seasonal test portion 106 receives information from input data portion 102 via communication channel 148, from alpha portion 116 via a communication channel 164 from beta portion 118 via a communication channel 166 from gamma portion 120 via a communication channel 168 and from phi portion 122 via a communication channel 170. Select portion 108 receives information from intermittent test portion 104 via a communication channel 152 from seasonal test portion 106 via a communication channel 154 and from input data portion 102 via a communication channel 156. Crosten portion 110 receives information from select portion 108 via a communication channel 158. Flat processing portion 112 receives information from select portion 108 via a communication channel 160 from initialize portion 114 via a communication channel 162 from alpha portion 116 via communication channel 164, from beta portion 118 via communication channel 166, from gamma portion 120 via communication channel 168 from phi portion 122 via communication channel 170. Seasonal processing portion 124 receives information from select portion 108 via a communication channel 171, from initialize portion 114 via a communication channel 172 from alpha portion 116 via a communication channel 173 from beta portion 118 via a communication channel 174 from gamma portion 120 via a communication channel 175 from phi portion 122 via a communication channel 176. Model selection portion 126 receives information from Crosten portion 110 via a communication channel 178 from flat processing portion 112 via a communication channel 180, from seasonal processing portion 124 via a communication channel 182 and from result data portion 136 via a communication channel 183. Forecast portion 127 receives information from model selection portion 126 via a communication channel 184 and from input data portion 138 via a communication channel 190. Damping portion 128 receives information from model selection portion 126 via a communication channel 186. Weekly indexing portion 130 receives information from damping portion 128 via a communication channel 188. Storage portion 140 receives information from weekly indexing portion 130 via a communication channel 192. Input data portion 138 receives information from storage portion 140 via a communication channel 194. Result data portion 136 receives information from storage portion 140 via a communication channel 196. Global communication network 142 communicates bi-directionally with storage portion 140 via a communication channel 198 and with computing device 144 via a communication channel 199.

In operation, computing device 144 provides historical information to input data portion 102 and result data portion 136. Intermittent test portion 104 performs an intermittent test on the information received from input data portion 102. Seasonal test portion 106 performs a seasonal test on the information received from input data portion 102. Based upon the information communicated from intermittent test portion 104 and seasonal test portion 106, select portion 108 provides information received from input data portion 102 to Crosten portion 110, flat processing portion 112 or seasonal processing portion 124. If intermittent test portion 104 determines the information is intermittent, then select portion 108 provides information to Crosten portion 110, then if seasonal test portion 106 determines the information is seasonal, then select portion 108 provides information to seasonal processing portion 124, otherwise the information is provided to flat processing portion 112. Depending upon which receives information, Crosten portion 110, flat processing portion 112 or seasonal processing portion 124 generate forecast models. Model selection portion 126 receives the forecast models and result information and then selects a model for application. Forecast portion 127 receives a forecasting model from model selection portion 126 and receives information from input data portion 138 and generates information associated with a forecast. Damping portion 128 receives the forecast information and performs damping. Weekly indexing portion receives the dampened forecast information and performs weekly indexing. Weekly indexing communicates the forecasted, damped and indexed information via storage portion 140 and global communication network 142 to computing device 144 for processing and presentation.

As a non-limiting example, forecast portion 127 generates monthly forecast segments. Furthermore, the monthly forecast segments may be spread out evenly based upon the number of weekly segments or distributed to weekly segments using weekly indexing rules. Furthermore, the weekly index rules process an index per a respective week of demand history associated with 52 weeks. Furthermore, the index may then be used for processing a weekly forecast.

Furthermore, forecast portion 127 may perform demand cleansing of information provided via input data portion 138. For demand cleaning, forecast portion 127 processes the demand history in order to identify demand information that is statistically higher or lower than a configurable number of standard deviations associated with the respective time period. This demand cleansing process aids in preventing one-time anomalies from being repeated in order to smooth data and improve accuracy associated with forecast processing. Furthermore, the demand cleansing process reduces user maintenance, decreases demand noise and improves accuracy of forecasts.

The percent weightings of previous years history is stored by each unique set of demand history such that the weightings can be configured differently for each individual set of demand history if desired. Furthermore, this capability being stored at this granularity provides the capability to create different weightings of previous years' demand as inputs to the weekly forecasts for any combination of items being forecasted without the need to write custom programs.

Weekly indexing portion 130 may be enabled for processing or disabled for processing.

Weekly indexing portion 130 performs processing as the last portion associated with forecast modeling.

Weekly indexing portion 130 performs an even distribution of weekly forecasts within a month associated with months having a flat or straight line forecast (e.g. no seasonality).

Weekly weighting noted as evenly distributed within a month may be applied when at least 24 months of demand history is not available for processing.

Information associated with weeks for zero-weighted months may be excluded in weighting calculations.

Zero weekly forecasts are undesirable in some applications or forecasting (e.g. retail inventory forecasting) because in essence zero sales are being planned for those weeks. Forecast policy may be modified in order to prevent the perpetuation of zero weekly forecasts. Weekly index forecasts are not indexed for a month with two or more consecutive weeks of zeros and alternatively use even weekly weighting associated with the respective month. This averages out the zero forecasts.

Weekly indexing portion 130 allows configurable weighting of individual years of historical data. It can then automatically calculate the weighting of each week of historical data to use in the weighting of the forecast weeks as follows. The percent of the total historical month associated with the week's historical data is calculated and following monthly modeling, the forecast week uses the stored values for yearly weighting, as described above, and multiplies the history year's weighting by the history week's percent of the month to get the weighting of the forecast week relative to its forecast month.

Processing associated with seasonal processing portion 124 is given priority over flat processing portion 112 when seasonality is detected. As a non-limiting example, the seasonal forecast model with the lower error is selected if below the standard error tolerance. As a non-limiting example, the standard error tolerance may be configured for 3%. Furthermore, if a seasonal forecast model is not found, then the flat forecast models are processed. Furthermore, the flat model forecast with the lower standard error tolerance may then be selected as the forecast model selected for processing.

Configuring alpha portion 116, beta portion 118, gamma portion 120 and phi portion 122 to provide a discrete number of values reduces the number of state space models that are processed as compared to academic systems.

As a non-limiting example, forecasting system 100 may be configured to apply 480 forecast combinations for identifying a forecast model.

Via computing device 144, a user (not shown) may override forecast variables and compare override cases versus non-override/statistical cases.

Via computing devices, users may collaborative perform forecast processing.

Forecasting system 100 provides capability to produce forecast accuracies of 95% or more.

FIG. 1 is a block diagram an example forecasting system where historical information is processed based upon intermittent, seasonal and non-seasonal for generating and selecting a forecast model which receives information for generating a forecast.

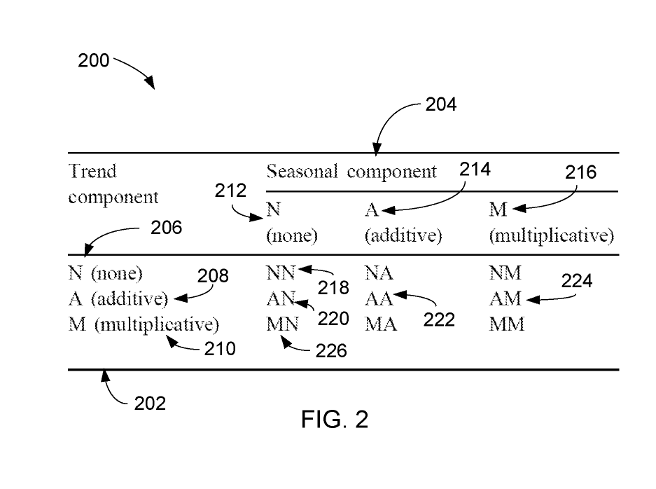

FIG. 2 presents an example table of forecast models for the example forecasting system described with reference to FIG. 1, in accordance with an embodiment of the present invention.

A table 200 includes a trend component 202 and a seasonal component 204.

Trend component 202 describes a forecast model associated with a trend. Seasonal component 204 describes a forecast model associated with a season.

Trend component 202 includes a non-trend component 206 noted as “N”, an additive trend component 208 noted as “A” and a multiplicative trend component 210 noted as “M”.

Non-trend component 206 represents a forecast model not having a trend component. Additive trend component 208 represents a forecast model as having an additive trend component. Multiplicative trend component 210 represents a forecast model as having a multiplicative component.

Seasonal component 204 includes a non-seasonal component 212 noted as “N”, an additive seasonal component 214 noted as “A” and a multiplicative seasonal component 216 noted as “M”.

Non-seasonal component 212 represents a forecast model not having a seasonal component. Additive seasonal component 214 represents a forecast model having an additive seasonal component. Multiplicative seasonal component 216 represents a forecast model having a multiplicative seasonal component.

A cell 218 noted as “NN” describes an exponential smoothing forecast model. A cell 220 noted as “AN” describes Holt's linear forecast model. A cell 222 noted as “AA” is describes the additive Holt-Winters' forecast model. A cell 224 noted as “AM” describes the multiplicative Holt-Winters' forecast model.

An equivalent state space formulation with a single source of error may be derived for the 9 forecast models presented in table 200. Furthermore, a calculation for the likelihood may be performed for the 9 forecast models which may be used to compute prediction intervals for respective forecast models.

For the 9 forecast models presented in table 200, there are two possible state space models, one corresponding to the additive error and one corresponding to the multiplicative error. The two forecast models give equivalent point forecasts although with different prediction intervals and different likelihoods.

Flat processing portion 112 (FIG. 1) and seasonal processing portion 124 (FIG. 1) may be configured to provide a multiplicity of forecast models for analysis associated with the forecast models presented by table 200.

The 9 exponential smoothing forecast models may be represented by Equations 1-3 shown below:

lₜ=αPₜ+(1−α)Qₜ (1)

bₜ=βRₜ+(φ−β)bₜ₋₁ (2)

sᵣ=γTₜ+(1+γ)sₜ₋ₘ (3)

Where lₜ denotes the series level at time t, bₜ denotes the slope at time t, sₜ denotes the seasonal component of the series at time t and m denotes the number of seasons in a year. Furthermore, the values Pₜ, Qt, Rₜ and Tₜ vary according to which of the cells associated with table 200. Furthermore, α, β, γ, and □ are constants as provided by alpha portion 116, beta portion 118, gamma portion 120 and phi portion 122, respectively, as described with reference to FIG. 1.

Flat processing portion 112 performs processing based upon cell 218 (“NN”), cell 220 (“AN”) and a cell 226 (“MN”).

FIG. 2 presents an example table of forecast models for the example forecasting system described with reference to FIG. 1 where the exponential smoothing forecast models may be represented as equations.

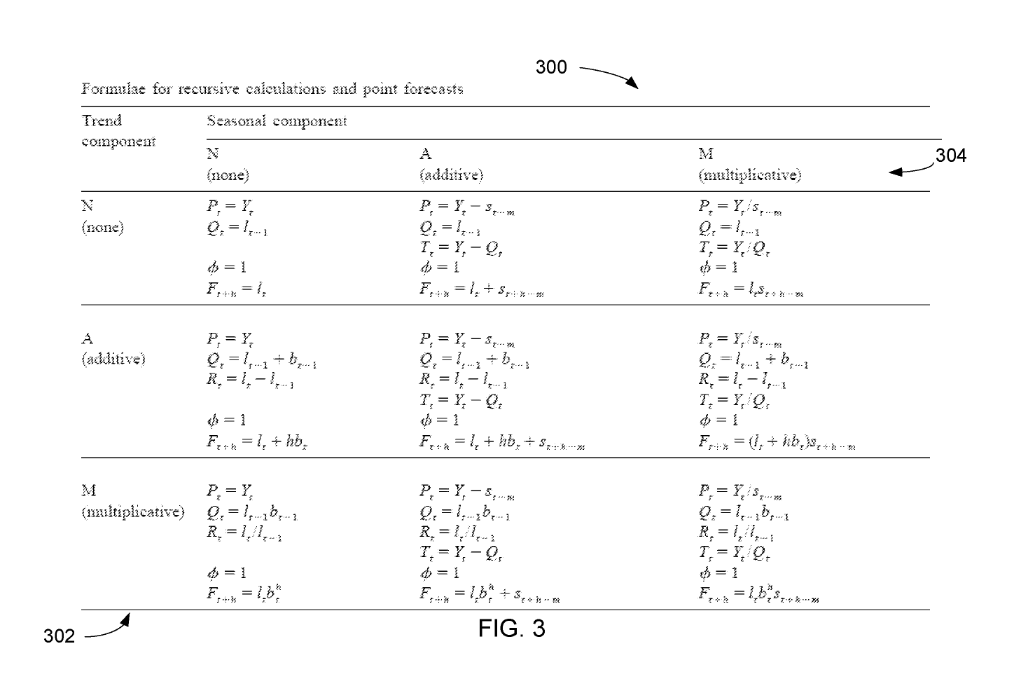

FIG. 3 presents an example table of recursive calculations for the example forecasting system described with reference to FIG. 1, in accordance with an embodiment of the present invention.

A table 300 includes a trend component 302 and a seasonal component 304.

Trend component 302 represents recursive calculations associated with a trend. Seasonal component 304 represents recursive calculations associated with a season.

Table 300 presents the values of P, Q, R, and T as described with reference to FIG. 2 and the formulae for computing point forecasts h periods ahead.

For the forecast models as described with reference to FIG. 2, a forecast model with additive errors and a forecast model with multiplicative errors may be obtained. The point-wise forecasts for the two models are the same, however the prediction intervals may differ.

The general framework involves a state vector x, and state space equations of the form as described by Equation 4 and Equation 5 shown below:

Yₜ=h(xₜ₋₁)+k(xₜ₋₁)εₜ (4)

xₜ=f(xₜ₋₁)+g(xₜ₋₁)εₜ (5)

Where {εₜ} represents a Gaussian white noise process with mean zero and variance σ². The variable xₜ may be defined as equal to (lₜ, bₜ, sₜ, sₜ₋₁, . . . sₜ₋₍ₘ₋₁₎). Furthermore, the variable e, may be defined as k(xₜ₋₁) εₜ. Furthermore, the variable μₜ may be defined as equal to h(xₜ₋₁). Furthermore, Yₜ=μₜ+εₜ.

The forecast model with additive errors may be described as Yₜ=μₜ+εₜ, where μₜ=F₍ₜ₋₁₎₊₁₎ denotes the one-step forecast made at time t−1. Furthermore, for this case, k(xₜ₋₁)=1.

The forecast model with multiplicative errors may be written as Yₜ=μₜ(1+eₜ). Furthermore, k(xₜ₋₁)=μₜ for this forecast model and εₜ=eₜ/μₜ=(Yₜ−μₜ)/μₜ. Furthermore, εₜ represents a relative error for the multiplicative forecast model.

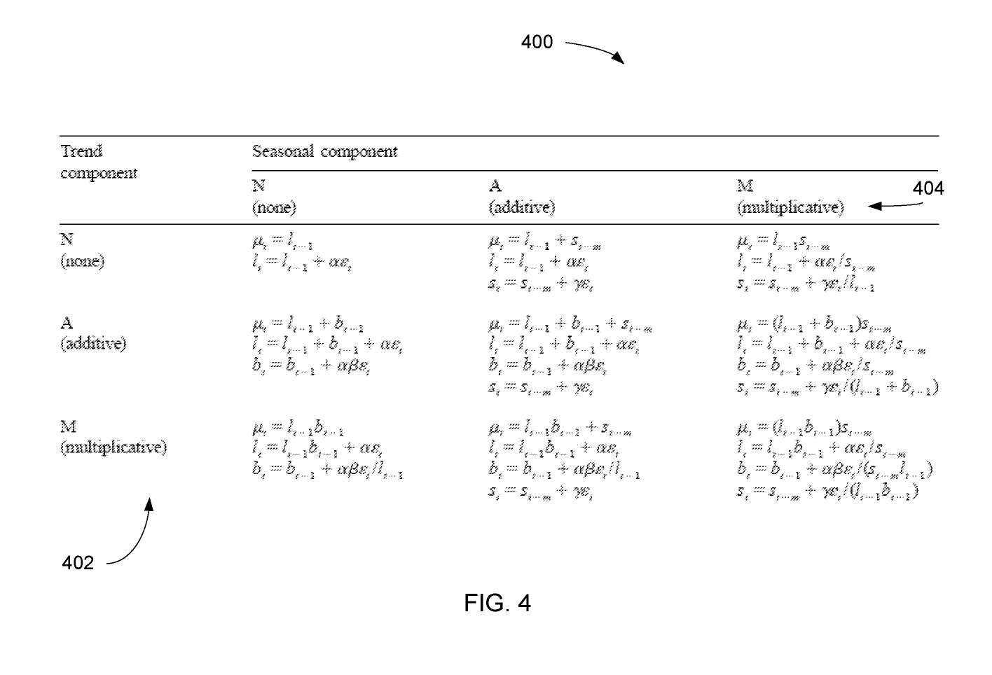

The forecast models presented in table 300 may be written in the form of Equation 4 and Equation 5 and are further described with reference to FIG. 4.

The difference between the additive error and multiplicative error models is in the observation equation described by Equation 4. The state equation described by Equation 5 may be configured in the same form as Equation 4 by substituting εₜ=eₜ/k(xₜ₋₁) into the respective state equation.

FIG. 3 presents an example table of recursive calculations for the example forecasting system described with reference to FIG. 1 where additive errors and multiplicative errors may be described via an equation.

FIG. 4 presents an example table of state space equations for the example forecasting system described with reference to FIG. 1, in accordance with an embodiment of the present invention.

A table 400 includes a trend component 402 and a seasonal component 404.

Trend component 402 represents state space equations associated with a trend. Seasonal component 404 represents state space equations associated with a season.

The state space equations presented in table 400 represented additive error forecast model. Multiplicative error models may be obtained by replacing εₜ with μₜεₜ.

The estimation and model selection as performed by model selection portion 126 (FIG. 1) is performed via calculation of Equation 6 shown below:

T*(□,X₀)=standard deviation of Dₙ (6)

Where Dₙ represents an array associated with the calculation of (H−F)/F for the respective month n of demand history associated with an item at a stocking location. As a non-limiting example, the number of months may be configured for up to 36 months. Furthermore, H represents the demand history associated with a month. Furthermore, F represents the fitted value calculation for the associated month as calculated by the state space formula. Furthermore, □={α, β, γ, □} and X₀={l₀, b₀, s₀, s₁, . . . sₙ).

In operation, minimization processing is performed for T*.

FIG. 4 presents an example table of state space equations for the example forecasting system as described with reference to FIG. 1 associated with the additive error model.

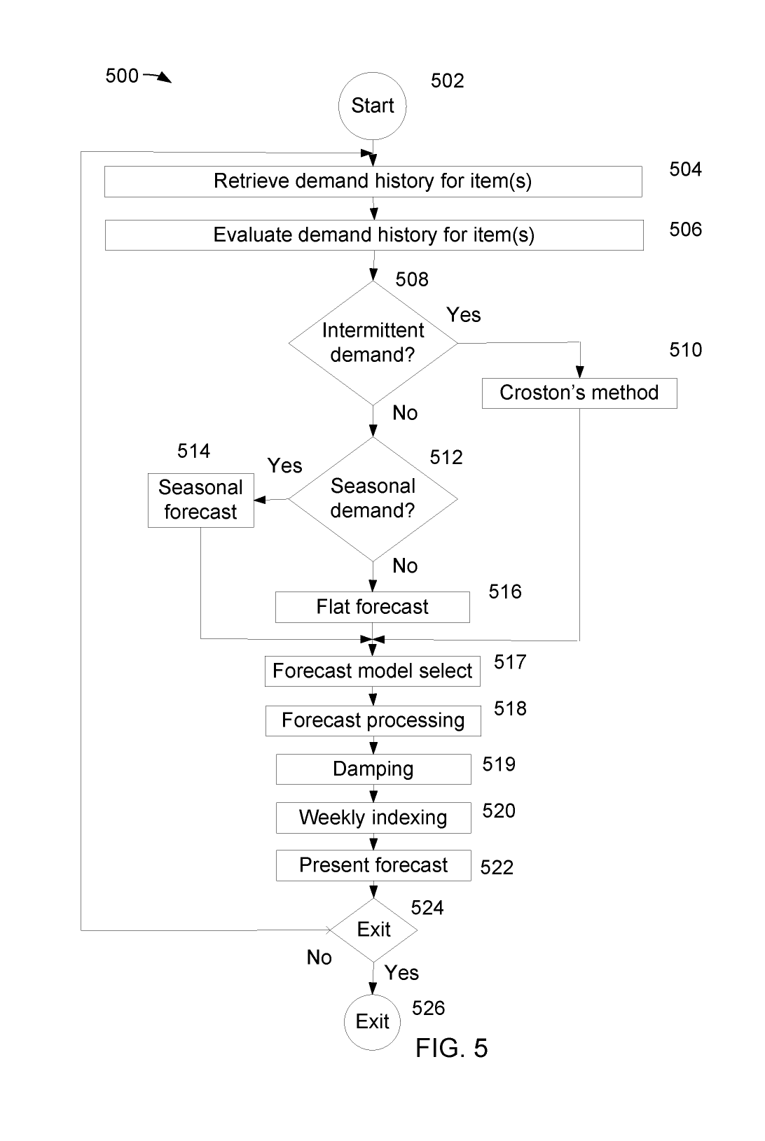

A method of performing the operation of the forecasting system as described with reference to FIGS. 1-4 will now be described with reference to FIG. 5.

FIG. 5 illustrates an example method for the forecasting system as described with reference to FIGS. 1-4, in accordance with an embodiment of the present invention.

Referring to FIG. 5, a method 500 initiates in a step 502.

Then in a step 504, demand history associated item or items is retrieved.

Demand history for an item or items is communicated from storage portion 140 (FIG. 1) to input data portion 102 (FIG. 1). Furthermore, results information is communicated from storage portion 140 (FIG. 1) to result data portion 136 (FIG. 1). As a non-limiting example, demand history for an automobile may be retrieved in order to perform a forecast for future sales of the automobile.

Referring back to FIG. 5, then in a step 506 demand history is evaluated.

Demand history is received and processed by intermittent test portion 104 (FIG. 1) and seasonal test portion 106 (FIG. 1).

Referring back to FIG. 5, then in a step 508 a determination is performed as to whether demand is intermittent.

Select portion 108 selects to provide demand history information based upon the information received from intermittent test portion 104 (FIG. 1) and seasonal test portion 106 (FIG. 1). As a non-limiting example, intermittent demand test is performed by calculating the number of months in demand history by counting back to the oldest non-zero history month. Furthermore, processing is performed to determine if 30% or more of the information associated with demand history months is zero. If 30% or more of zeroes are detected, then the demand is noted as intermittent and if not, then demand is noted as not intermittent.

Referring back to FIG. 5, for a determination of intermittent demand in step 508, then in a step 510 Crosten's forecasting method is performed.

Crosten portion 110 (FIG. 1) receives demand history information from select portion 108 (FIG. 1) and performed Crosten forecast processing.

Referring back to FIG. 5, for a determination of not intermittent demand in step 508, then in a step 512 a determination for seasonal demand is performed.

Select portion 108 (FIG. 1) provides demand history based upon the information received from seasonal test portion 106 (FIG. 1).

Referring back to FIG. 5, for a determination of seasonal demand in step 512, then in a step 514 seasonal forecasting is performed.

Seasonal processing portion 124 (FIG. 1) receives demand history information from select portion 108 (FIG. 1), receives alpha values from alpha portion 116 (FIG. 1), receives beta values from beta portion 118 (FIG. 1), receives gamma values from gamma portion 120 (FIG. 1), receives phi values from phi portion 122 (FIG. 1) and performs seasonal forecast processing. For seasonal processing, seasonal multiplicative or seasonal additive forecast models are evaluated for solutions based upon percent error. As non-limiting example, the percent error is evaluated for less than 3%.

Referring back to FIG. 5, for a determination of not seasonal demand in step 512, then in a step 516 flat forecasting is performed.

Flat processing portion 112 (FIG. 1) receives demand history information from select portion 108 and performs flat forecast processing.

Referring back to FIG. 5, then in a step 517 a forecast model selection is performed.

Model selection portion 126 (FIG. 1) receives forecast model results and results information from result data portion 136 (FIG. 1) and selects a forecast model.

Referring back to FIG. 5, then in a step 518 forecast processing is performed.

Forecast portion 127 (FIG. 1) receives forecast model from model selection portion 126 (FIG. 1), receives input stimulus from input data portion 138 (FIG. 1) and performs forecast processing.

Referring back to FIG. 5, then in a step 519 damping is performed.

Damping portion 128 (FIG. 1) receives forecast information from forecast portion 127 (FIG. 1) and performs damping processing. As a non-limiting example, forecast may be processed such that the forecast is not less than a percentage of the prior year's demand. As a non-limiting example, the percentage for comparing may be configured as 10%. Furthermore, the percentage for comparing may be adjustable. Furthermore, damping may be configured based upon an industry's acceptable negative trend information or constraints.

Referring back to FIG. 5, then in a step 520 weekly indexing is performed.

Weekly indexing portion 130 (FIG. 1) receives damped forecast information from damping portion 128 (FIG. 1) and performs weekly indexing. As a non-limiting example, previous year's demand is compared for the same week in order to weight the week versus other weeks with respect to the month. Furthermore, demand spikes may be ignored based upon a configurable tolerance. Furthermore, demand associated with a year or years may be weighted based upon a configurable ratio.

Referring back to FIG. 5, then in a step 522 damped and indexed forecast information is presented for viewing.

Damped and indexed forecast information is communicated to computing device 144 (FIG. 1) by way of storage portion 140 (FIG. 1) and global communication network 142 (FIG. 1). Furthermore, damped and indexed forecast information is presented for viewing via computing device 144 (FIG. 1). As a non-limiting example, forecast may be a 52 week forecast. As a non-limiting example, processed forecast settings may be stored within storage portion 140 (FIG. 1) and may be presented for viewing via computing device 144 (FIG. 1). As a non-limiting example, forecast information may be presented via a forecasting application. Furthermore, forecast information may be presented via a browser. Furthermore, forecast information may be securely presented via secure Hypertext Transfer Protocol (HTTP).

Referring back to FIG. 5, a determination for exiting method 500 is performed in a step 524.

For a determination of not exiting method 500 in step 524, execution of method 500 transitions to step 504.

For a determination if exiting method 500 in step 524, execution of method 500 terminates in a step 526.

FIG. 5 illustrates an example method for the forecasting system as described with reference to FIGS. 1-4 where demand history is retrieved, demand history is evaluated, intermittent demand processing is performed, seasonal demand processing is performed, forecast is performed, damping is performed and forecast is presented for viewing.

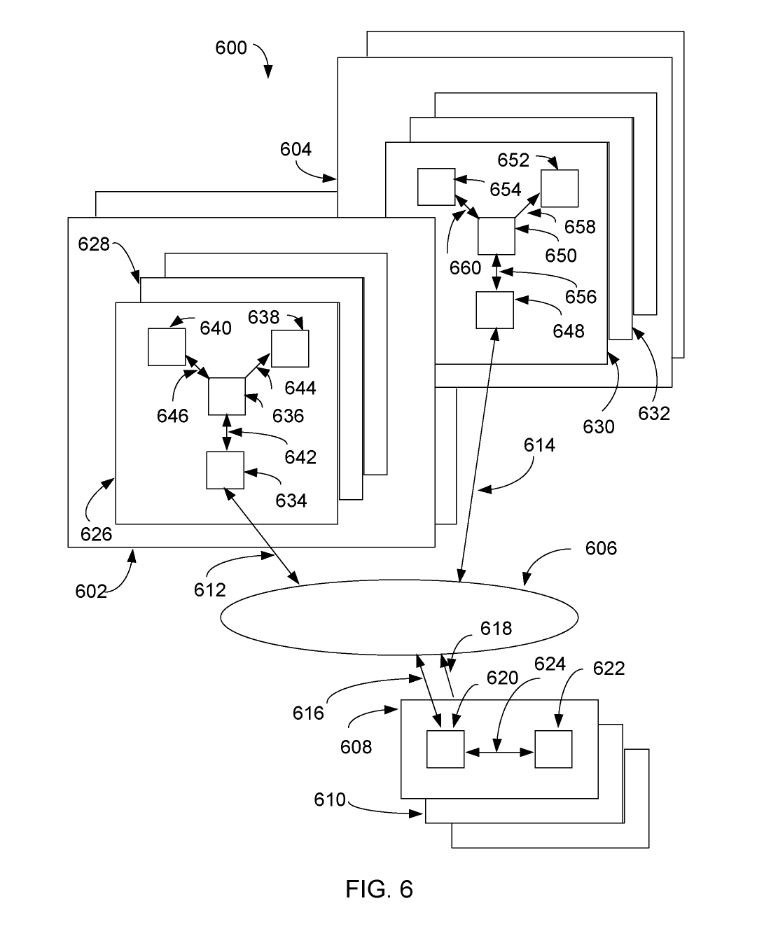

FIG. 6 illustrates a block diagram depicting a conventional client/server communication system.

A communication system 600 includes a multiplicity of networked regions with a sampling of regions denoted as a network region 602 and a network region 604, a global network 606 and a multiplicity of servers with a sampling of servers denoted as a server device 608 and a server device 610.

Network region 602 and network region 604 may operate to represent a network contained within a geographical area or region. Non-limiting examples of representations for the geographical areas for the networked regions may include postal zip codes, telephone area codes, states, counties, cities and countries. Elements within network region 602 and 604 may operate to communicate with external elements within other networked regions or within elements contained within the same network region.

In some implementations, global network 606 may operate as the Internet. It will be understood by those skilled in the art that communication system 600 may take many different forms. Non-limiting examples of forms for communication system 600 include local area networks (LANs), wide area networks (WANs), wired telephone networks, cellular telephone networks or any other network supporting data communication between respective entities via hardwired or wireless communication networks. Global network 606 may operate to transfer information between the various networked elements.

Server device 608 and server device 610 may operate to execute software instructions, store information, support database operations and communicate with other networked elements. Non-limiting examples of software and scripting languages which may be executed on server device 608 and server device 610 include C, C++, C# and Java.

Network region 602 may operate to communicate bi-directionally with global network 606 via a communication channel 612. Network region 604 may operate to communicate bi-directionally with global network 606 via a communication channel 614. Server device 608 may operate to communicate bi-directionally with global network 606 via a communication channel 616. Server device 610 may operate to communicate bi-directionally with global network 606 via a communication channel 618. Network region 602 and 604, global network 606 and server devices 608 and 610 may operate to communicate bi-directionally and also communicate bi-directionally with other networked device located within communication system 600.

Server device 608 includes a networking device 620 and a server 622. Networking device 620 may operate to communicate bi-directionally with global network 606 via communication channel 616 and with server 622 via a communication channel 624. Server 622 may operate to execute software instructions and store information.

Network region 602 includes a multiplicity of clients with a sampling denoted as a client 626 and a client 628. Client 626 includes a networking device 634, a processor 636, a GUI 638 and an interface device 640. Non-limiting examples of devices for GUI 638 include monitors, televisions, cellular telephones, smartphones and PDAs (Personal Digital Assistants). Non-limiting examples of interface device 640 include pointing device, mouse, trackball, scanner and printer. Networking device 634 may communicate bi-directionally with global network 606 via communication channel 612 and with processor 636 via a communication channel 642. GUI 638 may receive information from processor 636 via a communication channel 644 for presentation to a user for viewing. Interface device 640 may operate to send control information to processor 636 and to receive information from processor 636 via a communication channel 646. Network region 604 includes a multiplicity of clients with a sampling denoted as a client 630 and a client 632. Client 630 includes a networking device 648, a processor 650, a GUI 652 and an interface device 654. Non-limiting examples of devices for GUI 638 include monitors, televisions, cellular telephones, smartphones and PDAs (Personal Digital Assistants). Non-limiting examples of interface device 640 include pointing devices, mousse, trackballs, scanners and printers. Networking device 648 may communicate bi-directionally with global network 606 via communication channel 614 and with processor 650 via a communication channel 656. GUI 652 may receive information from processor 650 via a communication channel 658 for presentation to a user for viewing. Interface device 654 may operate to send control information to processor 650 and to receive information from processor 650 via a communication channel 660.

For example, consider the case where a user interfacing with client 626 may want to execute a networked application. A user may enter the IP (Internet Protocol) address for the networked application using interface device 640. The IP address information may be communicated to processor 636 via communication channel 646. Processor 636 may then communicate the IP address information to networking device 634 via communication channel 642. Networking device 634 may then communicate the IP address information to global network 606 via communication channel 612. Global network 606 may then communicate the IP address information to networking device 620 of server device 608 via communication channel 616. Networking device 620 may then communicate the IP address information to server 622 via communication channel 624. Server 622 may receive the IP address information and after processing the IP address information may communicate return information to networking device 620 via communication channel 624. Networking device 620 may communicate the return information to global network 606 via communication channel 616. Global network 606 may communicate the return information to networking device 634 via communication channel 612. Networking device 634 may communicate the return information to processor 636 via communication channel 642. Processor 636 may communicate the return information to GUI 638 via communication channel 644. User may then view the return information on GUI 638.

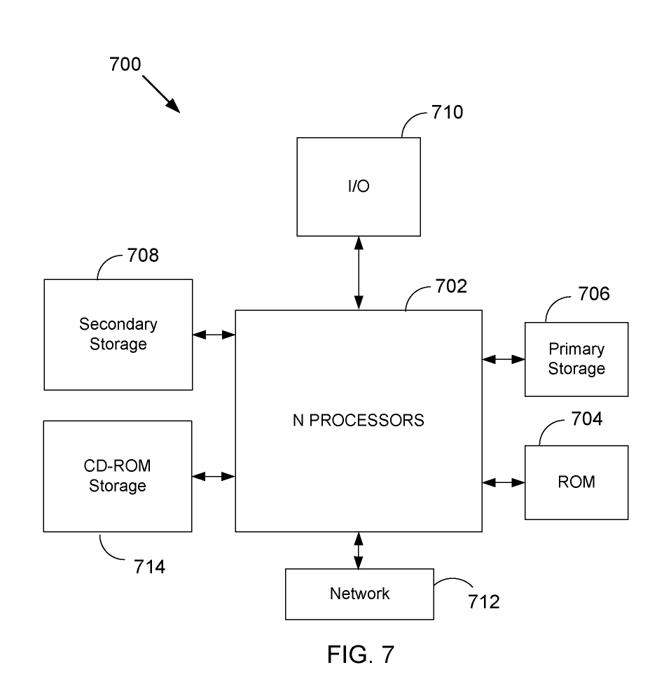

FIG. 7 illustrates a typical computer system that, when appropriately configured or designed, may serve as a computer system 700 for which the present invention may be embodied.

Computer system 700 includes a quantity of processors 702 (also referred to as central processing units, or CPUs) that may be coupled to storage devices including a primary storage 706 (typically a random access memory, or RAM), a primary storage 704 (typically a read-only memory, or ROM). CPU 702 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 704 acts to transfer data and instructions uni-directionally to the CPU and primary storage 706 typically may be used to transfer data and instructions in a bi-directional manner. The primary storage devices discussed previously may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and typically may be used as a secondary storage medium such as a hard disk. It will be appreciated that the information retained within mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection shown generally as a network 712, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a forecasting system according to the present invention will be apparent to those skilled in the art. The invention has been described above by way of illustration, and the specific embodiments disclosed are not intended to limit the invention to the particular forms disclosed. For example, the particular implementation of the computing devices may vary depending upon the particular type of computing devices used. The computing devices described in the foregoing were directed to laptop computing implementations; however, similar techniques using mobile computing device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

1. A method for forecasting implemented by one or more computer storage media storing computer-usable instructions, that when used by one or more computing devices, cause the one or more computing devices to perform the method comprising the steps of:
selecting at least one item and historical demand information for the item from a storage portion;
specifying a plurality of discrete values for use with forecast models, said discrete values reducing a number of state space models to be processed, said discrete values at least comprising an alpha value, a beta value, a gamma value and a phi value;
communicating the item, historical demand information and discrete values to a computer forecasting unit comprising: at least one test portion being configured for testing the historical demand information to determine a type for the historical demand information; a selection portion being configured for selecting at least a one of a plurality of forecast model portions and for transferring the historical demand information to the selected forecast model portion; a model selection portion being configured for selecting at least one of a plurality of forecast models from the selected forecast model portion; and a forecast portion being configured to generate a forecast using at least the historical demand information and the selected forecast model; and
receiving the forecast.

2. The method as recited in claim 1, in which the testing portion is configured for determining if the historical demand information is intermittent and for determining if the historical demand information is seasonal.

3. The method as recited in claim 2, in which the selection portion selects a Croston forecast model portion for intermittent historical demand information.

4. The method as recited in claim 2, in which the selection portion selects a seasonal forecast model portion for seasonal historical demand information.

5. The method as recited in claim 2, in which the selection portion selects a flat forecast model portion for non-intermittent and for non-seasonal historical demand information.

6. The method as recited in claim 1, in which the forecasting unit further comprises a damping portion being configured for damping the generated forecast by a selectable percentage of a prior year.

7. The method as recited in claim 6, in which the damping portion processes the generated forecast by comparison to a prior year historical demand information.

8. The method as recited in claim 6, in which the forecasting unit further comprises a weekly index portion being configured for indexing the damped generated forecast.

9. The method as recited in claim 8, in which the weekly index portion processes the damped generated forecast by comparison to a prior year's weekly historical demand information.

10. A system comprising:
a client unit being configured for selecting at least one item and historical demand information for the item from a storage portion and for specifying a plurality of discrete values for use with forecast models, said discrete values reducing a number of state space models to be processed, said discrete values at least comprising an alpha value, a beta value, a gamma value and a phi value; and
a computer forecasting unit being configured to be operable for communicating with said client unit, said forecasting unit comprising:
at least one test portion being configured for testing said historical demand information to determine a type for said historical demand information;
a selection portion being configured for selecting at least a one of a plurality of forecast model portions and for transferring said historical demand information to said selected forecast model portion;
a model selection portion being configured for selecting at least one of a plurality of forecast models from said selected forecast model portion; and
a forecast portion being configured to generate a forecast using at least said historical demand information and said selected forecast model in which said forecast is communicated to said client unit.

11. The system as recited in claim 10, in which said forecasting unit further comprises a damping portion being configured for damping said generated forecast by a selectable percentage comparison to a prior year historical demand information, and a weekly index portion being configured for indexing said damped generated forecast by comparison to a prior year's weekly historical demand information, said testing portion being further configured for determining if said historical demand information is intermittent and for determining if said historical demand information is seasonal, said selection portion further being operable for selecting a Croston forecast model portion for intermittent historical demand information, for selecting a seasonal forecast model portion for seasonal historical demand information and for selecting a flat forecast model portion for non-intermittent and non-seasonal historical demand information.

12. A non-transitory program storage device readable by a machine tangibly embodying a program of instructions executable by the machine to perform a method for forecasting, comprising:
computer code for selecting at least one item and historical demand information for the item from a storage portion;
computer code for specifying a plurality of discrete values for use with forecast models, said discrete values reducing a number of state space models to be processed, said discrete values at least comprising an alpha value, a beta value, a gamma value and a phi value;
computer code for communicating the item, historical demand information and discrete values to a forecasting unit comprising: at least one test portion being configured for testing the historical demand information to determine a type for the historical demand information; a selection portion being configured for selecting at least a one of a plurality of forecast model portions and for transferring the historical demand information to the selected forecast model portion; a model selection portion being configured for selecting at least one of a plurality of forecast models from the selected forecast model portion; and a forecast portion being configured to generate a forecast using at least the historical demand information and the selected forecast model; and
computer code for receiving the forecast.

13. The non-transitory program storage device as recited in claim 12, in which the testing portion is configured for determining if the historical demand information is intermittent and for determining if the historical demand information is seasonal.

14. The non-transitory program storage device as recited in claim 13, in which the selection portion selects a Croston forecast model portion for intermittent historical demand information.

15. The non-transitory program storage device as recited in claim 13, in which the selection portion selects a seasonal forecast model portion for seasonal historical demand information.

16. The non-transitory program storage device as recited in claim 13, in which the selection portion selects a flat forecast model portion for non-intermittent and for non-seasonal historical demand information.

17. The non-transitory program storage device as recited in claim 12, in which the forecasting unit further comprises a damping portion being configured for damping the generated forecast by a selectable percentage of a prior year.

18. The non-transitory program storage device as recited in claim 17, in which the damping portion processes the generated forecast by comparison to a prior year historical demand information.

19. The non-transitory program storage device as recited in claim 17, in which the forecasting unit further comprises a weekly index portion being configured for indexing the damped generated forecast.

20. The non-transitory program storage device as recited in claim 19, in which the weekly index portion processes the damped generated forecast by comparison to a prior year's weekly historical demand information.
